(19) United States
(12) Patent Application Publication
(10) Pub. No.: US 2021/0318008 A1
(43) Pub. Date: Oct. 14, 2021

(54) UV-C GERMICIDAL LED STRIP KITS FOR HVAC DUCTS

(71) Applicant: Purge Virus LLC, King of Prussia, PA (US)

(72) Inventor: Charles Attila Szoradi, King of Prussia, PA (US)

(21) Appl. No.: 17/301,442

(22) Filed: Apr. 2, 2021

Related U.S. Application Data
(60) Provisional application No. 63/004,001, filed on Apr. 2, 2020.

(51) Int. Cl. F24F 8/22; F24F 11/88; F24F 11/56; F24F 11/89

(52) U.S. Cl. CPC F24F 8/22; F24F 11/88; F24F 2110/10; F24F 11/89; F24F 11/56

(57) ABSTRACT

An air disinfection system comprising: a plurality of LED diodes mounted on an LED strip; a driver for driving the LED diodes to a given power; a DC power source configured for direct connection to the LED strip; the system configured for positioning within a heating, ventilation, and air-conditioning system (HVAC), wherein said system comprising at least a first LED strip and a second LED strip, said first LED strip mounted opposing said second LED strip within a void within an HVAC system; wherein an air passing through said void is contacted by irradiated light from the LED diodes.

### CROSS-REFERENCE TO RELATED APPLICATIONS

This application claims the benefit of U.S. Provisional Patent Application No. 63/004,001 filed on Apr. 2, 2020, with the United States Patent and Trademark Office, the contents of which are incorporated herein by reference in their entirety.

### FIELD OF THE INVENTION

This invention is related to LED-generated UV-C light oriented to generate log reductions in viral and bacterial loads within the air, and specifically within ducting systems.

### BACKGROUND OF THE INVENTION

HVAC ducts serve as a means for air capture and exchange within an indoor location. In many locations, it is critically important to mitigate the spread of infection by capturing or destroying airborne pathogens.

The prior art utilizes filtration strategies, typically in the form of pleated filters, with varying size pores to capture pathogens. However, these suffer from several issues, namely that they must be changed frequently, especially in locations with high pollen counts, and that any tear or disturbance of the pleated surface immediately and dramatically reduces effectiveness, as the air will take path of lowest resistance and flow through a tear or opening, instead of through the filter. In locations where filtration is utilized to capture pathogens, including viral, bacterial, spores or the like, clogged filters increase the risk of tears, and also dramatically decrease the efficiency of the system.

Certain devices utilize germicidal or UV lights to kill the DNA of germs, viruses, mold spores, bacteria, and fungi as they pass through an air handler. However, these lights suffer from known problems, including their limited lifetime. Notably, as output drops, effectiveness of these lights rapidly diminishes. The specific lifespan can also be reduced by coatings on the tube of the glass or space to hold the UV light, and their difficulty in changing the light to ensure replacement within the useful lifetime. Furthermore, their use of outdated technology increases the running cost of the bulbs, and their form leads to disturbances within air handling units which can also reduce their efficiency and effectiveness.

Applicant has identified UV-C killing power within an HVAC duct or an air handling unit, which can incorporate LED strips which provide for an appropriate light output in the UV-C range to effectively kill germs, viruses, mold spores, bacteria, and fungi as they pass through the light zone, and can perform this more efficiently, for a longer duration than prior UV-C bulbs and are overall more cost effective and effective. This leads to a new and useful product for use in HVAC systems.

### SUMMARY OF THE INVENTION

This invention is intended for installation within the respective HVAC trunk ducts and or the plenums. With the current status quo, if an infected person coughs in one room, the contaminated air is drawn out of the room and distributed to multiple other rooms that are supplied by the same trunk duct. With this invention, the contaminated air is disinfected before it is supplied back to the source room and the associated room on that section of the trunk duct. For this invention to be effective across a whole facility, design considerations are required to place the technology in the right places on a case-by-case basis.

In a preferred embodiment, an air disinfection system comprising: a plurality of LED diodes mounted on an LED strip; a driver for driving the LED diodes to a given power; and a DC power source configured for direct connection to the LED strip; the system configured for positioning within a heating, ventilation, and air conditioning (HVAC) system, wherein said system comprising at least a first LED strip and a second LED strip, said first LED strip mounted opposing said second LED strip within a void within the HVAC system; wherein air passing through said void is contacted by irradiated light from the LED diodes.

In a further preferred embodiment, the system wherein the LED diodes are driven at between 100 mA and 350 mA.

In a further preferred embodiment, the system wherein the LED diodes are driven to generate light with a peak between 255 nm and 280 nm.

In a further preferred embodiment, the system further comprising a sensor, said sensor detecting a flow of air and capable of modifying intensity of light based upon the flow of air.

In a further preferred embodiment, the system wherein the first LED strip and the second LED strip are mounted to irradiate a coil within the HVAC system.

In a further preferred embodiment, the system wherein said DC power source comprises multiple channels to power multiple LED devices in different areas of the HVAC system. In a further embodiment, the system wherein said DC power source has multiple channels to power multiple devices in different areas of any given building that may include multiple air handling units (AHUs) and ducts. In a further preferred embodiment, the system wherein said DC power source includes wireless controls.

In a further embodiment, a method of air disinfection by using ultraviolet wavelength light-emitting diodes (UV-LEDs) comprising: on opposing sides in a void within a heating, ventilation, and air conditioning (HVAC) system, mounting a plurality of UV-LEDs that are fixed on a circuit board and a backing element, which is attached to a surface within the HVAC system; detecting a flow of air through the HVAC system; and driving the UV-LEDs to a power sufficient to generate an output based upon the flow of air through the HVAC system.

In a further preferred embodiment, the method wherein the void is the inside of an HVAC duct.

In a further preferred embodiment, the method wherein the void is the inside of an HVAC air handling unit (AHU).

In a further preferred embodiment, the method wherein the backing element comprises an adhering agent. In a further preferred embodiment, the method wherein in the adhering agent is selected from the group consisting of: an adhesive, a magnet, a threaded fastener, a bracket and fastener, and combinations thereof.

In a further preferred embodiment, the method wherein the UV-LEDs are configured on an LED strip. In a further preferred embodiment, the method further comprising a DC power source, wherein the DC power source for the LED strip is local to each LED strip. In a further preferred embodiment, the method wherein the DC power source for the LED strip is remote from the LED strip through a power hub driver.

In a further preferred embodiment, the method further comprising: engaging a sensor to detect the flow of air through the HVAC system and modifying the output of the UV-LEDs based upon the flow of air.

In a further embodiment, a system for UV disinfection comprising: a plurality of UV-C LED diodes, each UV-C Diode positioned on a printed circuit board (PCB), and affixed to a backing on a LED strip; said LED strip electrically connected to a DC power source, for direct DC power to said LED strip; an HVAC void, wherein at least two LED strips are positioned substantially opposite of one another; and a sensor connected to said DC power source for detecting a parameter and capable of modifying the DC power source or an element of an HVAC system to modify a flow of air within the HVAC system.

In a further preferred embodiment, the system wherein the UV-C LED diodes are driven at between 100 mV and 350 mV and wherein the UV-C LEDs provide a light emission with a peak between 255 nm and 280 nm.

In a further embodiment, the system wherein said sensor is selected from the group consisting of: humidity, temperature, pressure, air speed, UV, lumens, irradiance, movement, and combinations thereof.

### BRIEF DESCRIPTION OF THE FIGURES

FIG. 1 depicts a cross section of an UV-C LED strip kit as set apart from a metal duct.

FIG. 2 depicts an elevated view of an UV-C LED strip kit (48″ long on average) shown here with LED driver and terminal mounted on printed circuit board (PCB). Note that this system also runs with optional remote, low voltage, power hub driver(s) to reduce the need for drivers powering each individual strip kit or multiples of kits.

FIG. 3 is an elevated view of an UV-C “Purge Zone” within HVAC duct (12′ to 16′ long on average) shown here with four pairs of UV-C LED strip kits. Contaminated air enters on the left and the sanitized air leaves the zone on the right.

FIG. 4 is a cross section of UV-C “Purge Zone” within HVAC duct (multiple sizes) shown here with all four UV-C Strip Kits activated, with two on each side of the HVAC duct interior.

FIGS. 5A, 5B and 5C are cross section of UV-C “Purge Zone” in HVAC duct (multiple sizes) shown here to illustrate the UV-C Strip Kits filling the Purge Zone with germicidal light. This system is designed for all of the UV Strip Kits to run concurrently, but shows in FIG. 5A, one strip, FIG. 5B, two strips, and FIG. 5C, three strip kits illuminated to show the intensity of light.

FIG. 6 is a cross section of UV-C “Purge Zone” in HVAC Air Handling Unit (AHU) between the coil and the duct. This area is often called the plenum, and the UV-C LED strips are mounted facing the coil for the added benefit of cleaning the coil of microorganisms for energy savings in addition to air disinfection.

FIG. 7 is an example of power hub driver (PhD) that turns alternating current into direct current and powers more than one LED strip that may be located in the save AHU or duct as well as across multiple areas of a building with different AHUs and ducts. The optional PhD also has wireless controls with connectivity through the internet of things (IoT) for modification of fan speed, closing of dampers, and the like.

FIG. 8 is a cross section of an UV-C LED strip kit in housing.

### DETAILED DESCRIPTION OF THE INVENTION

As used herein, the term “Ultraviolet-C” (UV-C) refers to ultraviolet light with wavelengths between 200-280 nanometers (nm). Light in the UV-C wavelength can be used for disinfecting water, sterilizing surfaces, and destroying harmful microorganisms in food products and in air.

Countries around the world face pandemics with costly economic implications, the cost of healthcare has increased, and buildings without operable exterior windows escalate concerns over sick building syndrome. The investment into this technology may become a “new normal” where building codes start to require some form of HVAC air disinfection or sterilization to mitigate infections, just as many building codes require smoke detectors and sprinkler systems to mitigate fire damage.

The labor cost of integrating this technology into the ducts in advance of construction will be less expense than the retrofit cost of installation. This invention may also have a positive economic impact through the creation of new manufacturing and installation jobs in this healthy building category.

The challenges to date for UV-C HVAC duct implementations include the high cost of UV-C hardware, installation, and maintenance as well as the costly impact on air flow requirements for HVAC systems. Germicidal fluorescent tubes, produced to achieve the adequate sterilization, typically have a life span of less than 10,000 hours. Given 8,760 hours in each year, changing the lights approximately every year for facilities like hospitals and hotels that run 24 hours per day, is often cost prohibitive, especially when the lights are hard to easily access inside of HVAC duct systems.

Fluorescent tubes are typically ¾″ to 1″ in diameter, and for this type of sterilization they have been mounted in pilot projects at the interior of ducts parallel to the air flow. The size of the fluorescent tubes creates resistance and increases the static pressure, in some cases by 20%.

The resulting slower speed of the air moving through the ducts changes the effectiveness of the HVAC air handlers relative to the original design at any given property. The change in the air flow can create costly alterations or upgrades to the HVAC system making use of these technologies difficult or impossible.

To meet stringent building and energy codes, power and lighting systems are undergoing an industry-wide transformation. Components need to be interactive, responsive, efficient, reliable, and in one word: smart. Herein, are described embodiments for the unexpected optimization of an HVAC system for UV-C disinfection of contaminants with a flow of air. Certain embodiments also include the use of a “power hub driver” (PhD) for added energy savings and reduced cost of installation. The power hub driver is a device that delivers DC currents without unnecessary conversions, to allow for high efficiency power conversion and power needed for a given unit. The PhD allows for specific control, namely to the output as it relates to a UV-C LED strip, and thus can be utilized to optimize the output to meet specific needs.

In particular, the embodiments herein detail the use of light emitting diodes (LEDs), which are semiconductor light source that emits light when current lows through a chip. Such lights are well known in the industry. LED lights can emit lights within the light spectrum to generate germicidal properties. UV-C light is optimized at about 265 nm, with output reducing both before and after that peak. LED bulbs can be created to optimize output of light in this light range to maximize the UV-C light generated so as to irradiate pathogens and microorganisms for air disinfection and energy savings. Preferred embodiments utilized a LED diode that has output between about 254 to about 280 nm. Further preferred embodiments have LED diodes which emit light within a peak of between about 255 and 280 nm, or about 260 to about 280 nm, or about 265 to about 280 nm, or about 270 to about 280 nm.

Given than UV-C is harmful to humans with direct exposure, UV-C has been used, to date, in devices that are often carried or rolled into rooms to sterilize the air or surfaces after humans have left the area. These systems often comprise a shielded exterior with a UV-C generating tube within a glass or polycarbonate housing, where air or liquids are passed over and around the glass housing at a given rate to allow for deactivation of organisms within the flow of the air or fluid. Such devices typically have a single setting for the light output and thus need to precisely match the flow over the glass housing so as to optimize the killing power. This brings forth numerous inefficiencies for their use.

Heating, Ventilation, and Air Conditioning (HVAC) ducts are ubiquitous in many different form factors across commercial and residential buildings around the world. They are required to capture air from a location and return it. Typically, HVAC systems utilize a filter and then either cool or heat the air before it is returned. In many settings the air filtration allows for removal of contaminants from the air, including but not limited to particulates, smoke, smog, pollen, dander, fungi, bacteria, spores, viruses, and the like. However, filtration is but one strategy for purifying air, as many or all of these contaminants can be destroyed or inactivated through other processes.

HVAC ducts serve as an excellent means to sterilize air using UV-C if the technology is cost effectively mounted inside the ducts. HVAC ducts are also ideal, because most buildings require multiple air changes per hour according to building code standards. Typical HVAC design includes a “trunk” duct that has multiple “branches” to supply air to individual rooms. Typical HVAC design also typically includes one or more air handling units (AHU) many of which have a plenum area between the coil and the ducts. This plenum area is often an ideal location for the LED strips. HVAC systems are necessary in both commercial and residential locations, and the embodiments herein can be utilized in any type of building including, but not limited to, hospitals, schools, and other commercial buildings, as well multifamily and single family properties to disinfect or sterilize air and help mitigate the spread of airborne pathogens that cause disease and viral infections.

Typical sterilization tubes are fluorescent tubes, having short lifetimes and difficult replacement, and high cost of replacement. Light-emitting diode (LED) technology presents a solution to reduce the maintenance challenge, because LEDs typically last significantly longer than fluorescent tubes. The longevity of LEDs also increases as market demand pushes manufacturers to compete and improve the performance of efficacy and longevity.

LEDs can be configured to reduce the adverse impact of air flow from tubes. Flow through HVAC systems can be specifically tailored to increase or decrease flow of air based on optimization of the HVAC system. For example, where less air is needed, fan speed and total volume of air can be reduced. This is easily accomplished with DC powered fans, which can be programmed to modify speed based on certain inputs. Sensors can be utilized to detect occupancy and to open and close dampers that increase or reduce the need for air flow in certain locations. However, the introduction of turbulences within the plenum of the HVAC system can reduce efficiency and increase operating costs. If LEDs were included on tubes mounted inside of ducts, they would create similar challenges as fluorescent tubes relative to the static pressure that slows the air flow. A typical 48″ long fluorescent or LED tube has a typical diameter of ¾″ and a radius of 0.375″. The cross section surface area is πr²: 3.14×.375²=0.44 in.².

Embodiments of this disclosure addresses the air flow issues presented by tubes within the plenums by eliminating the need for a “tube” and dramatically reducing the size of the UV-C hardware. The solution is to mount the LED UV-C diodes on a printed circuit board that is approximately ¼″ wide by approximately ⅛″ thick in varying lengths most likely 48″ for production and shipping logistical convenience, but also because its slim form factor can greatly reduce the losses that would come from typical tubes mounted inside of ducts or with a plenum of an HVAC system.

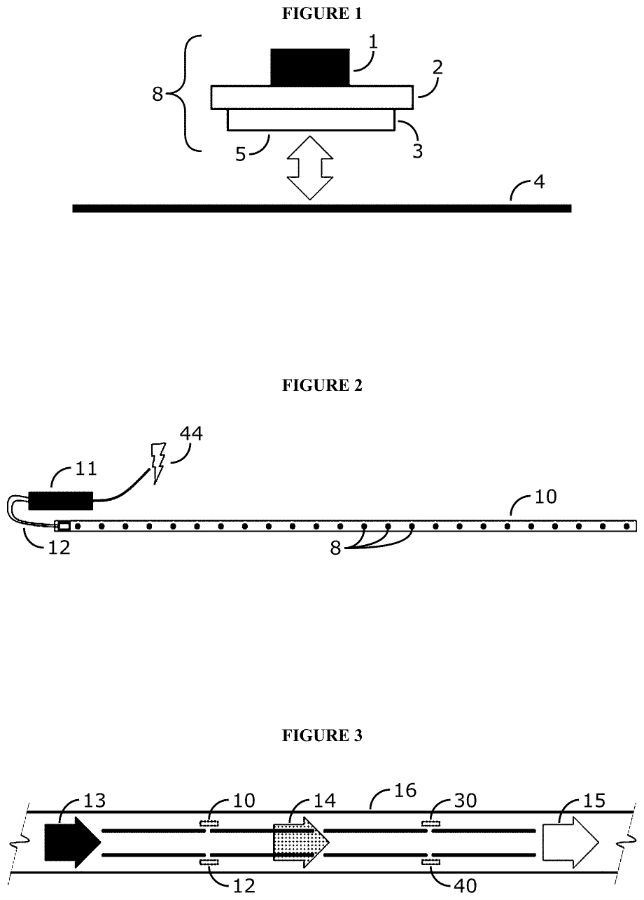

In view of FIG. 1, an LED diode (1) is positioned on a printed circuit board (PCB) (2). The PCB itself comprises a backing (3). Together, the LED diode (1), the PCB (2), and the backing (3) make up a LED light (8). Multiple LED lights (8) can be affixed in a strip, as depicted in other figures. The backing (3) with an adhering agent (5) on the bottom side of the backing (3), the adhering agent (5) is typically a magnet or an adhesive, able to engage with the surface (4). FIG. 1) is depicted with the backing (3) set apart from the surface (4), in an exploded view. Typically, the surface 4 is a metal duct, or a metal portion with an air handler or plenum in an HVAC system.

FIG. 2) details that multiple LED lights (8) can be attached to an LED strip (10), with a power source (44) connected to a driver (11) and connecting wiring (12) to power the LED diodes (1) on the strip. This allows for a plurality of LED diodes (1) to be placed adjacent to one another and to create significant amounts of UV-C light necessary to kill contaminants. A benefit of the LED strip (10) is that the cross section is about 0.25″×.125″=0.03125″. This is a dramatically smaller profile than the UV tubes, and it is a 92.8% reduction in the surface area that slows the air flow in HVAC ducts. If fluorescent or LED tubes impact the air flow by 20%, this LED strip solution would only impact the air flow by 1.4%. This creates a dramatic savings in efficiency of the system, especially where multiple tubes would exist. A strip may comprise a single diode or a grouping of diodes along the strip.

LEDs typically need some form of a heat sink to transfer the heat away from the diodes to foster longevity. Because of the position of the LED diodes within the HVAC system, the flow of air alone is sufficient to cool the LEDs. However, further exchanges of heat may be improved by use of a conductive material such as aluminum for the printed circuit board as well as a conductive backing, either via the adhesive or a magnet. This then connects to the duct (4), which serves as a large heat sink. By using the metallic ducting itself as a heat sink, the LED diodes (1) can stay cool, while imparting a nominal increase in heat to the system as a whole. The adhesive or magnet elements of the backing (3) are also utilized to increase the speed of the installation. Many LED printed circuit boards for linear modules are made of FR4, fiberglass-reinforced epoxy-laminates, given that it is less expensive than aluminum. However, these materials are still able to transfer heat to the duct (4), as well as allow the LED diode (1) to dissipate heat into the passing air.

The disadvantage of FR4 is that it is less conductive than aluminum. Most HVAC ducts are made of galvanized sheet metal to prevent rust and corrosion. Galvanized steel is covered with a thin layer of zinc, and this process does not interfere with the magnetic strength of the steel. For the embodiments herein, adhesives can be used as well as mounting support from self-taping screws, but the advantage of a magnet backing is that it helps to evenly transfer the heat from the diodes through the printed circuit board out of the ducts along the length of the printed circuit board. This invention also includes the optional LED housing (7) (See FIG. 8) with an adhering element (5), such as a magnet, adhesive, or screw mounting to the surface (4), with the PCB (2) attached to the housing (7), and the LED diode(s) positioned on the PCB.

Various configurations are provided by FIGS. 2-5. For example, the power supplies or driver (11), as connected to a wiring harness (12), and then connected to an LED strip (10), made up of numerous LED diodes (1), is depicted in FIG. 2. Those of skill in the art will recognize that many LED diodes (1) can be attached via a strip or oriented in a pattern on a PCB, to allow for a greater number of LED diodes (1) to be situated and driven by a single driver (11). The embodiments envision lengths of LED strips (10) comprising 2 to hundreds of LED diodes (1), at a length of a few inches to dozens of feet in length. Typical lengths are in the 10 to 20 foot range, with LED diodes spaced apart from one another at a distance of about 1 mm to about 500 mm. The LED diodes (1) can be individually positioned or oriented in parallel lines, along the length of an LED strip (10). When parallel, this allows two, three, four or more LED diodes (1) to be positioned roughly at the same distance from one end of the length of an LED strip (10), but it allows for dramatic increases in light intensity due to the collection of LED diodes (1) at one position.

FIG. 3 then depicts several LED strips 10, 20, 30, and 40), (not shown to size) which are aligned within a duct (16). Air flows from left to right (13 to 14 to 15), with untreated air entering at (13), with air being partially treated at (14) and fully treated at (15), as it exits the section of the duct (16) where UV-C light is treating the contaminated air. This allows for the LED strips (10, 20, 30, and 40) to irradiate a long length of duct (16) so as to create a greater dwell time for contaminants within the UV-C light.

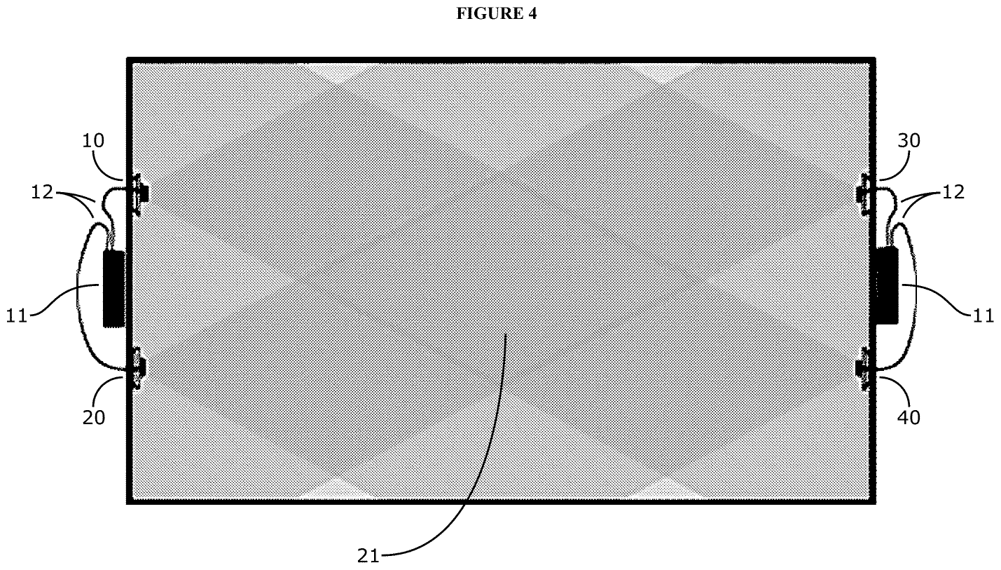

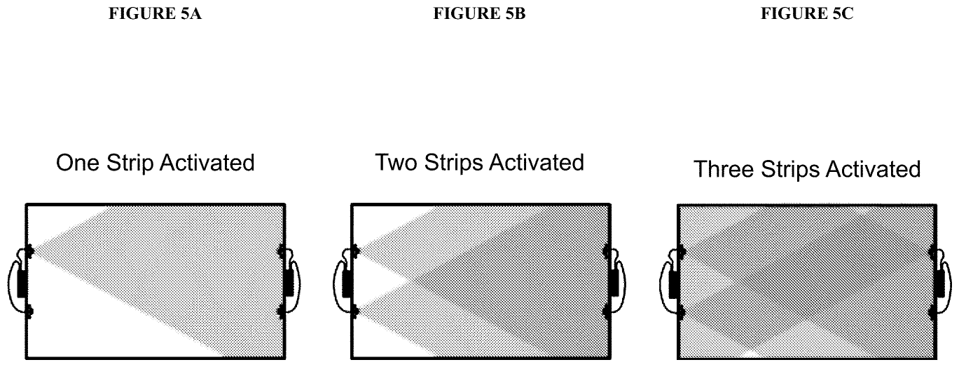

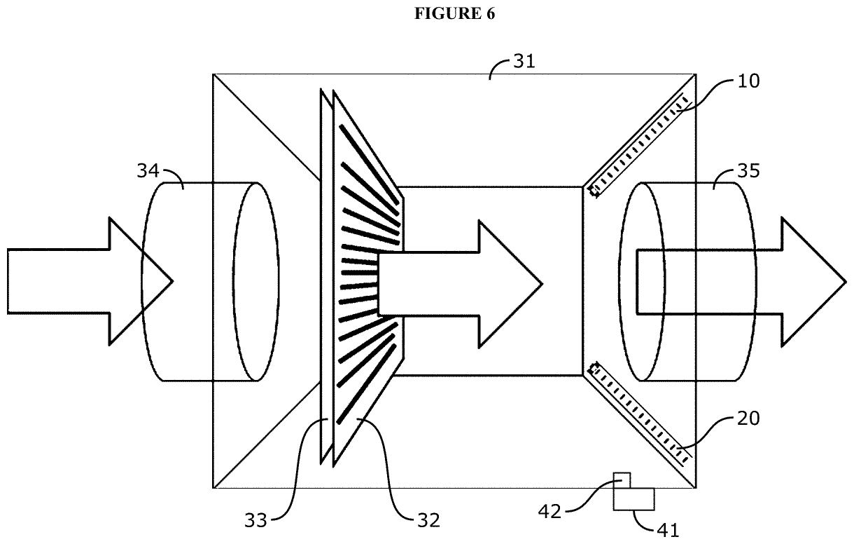

FIG. 4 details the use of LED strips (10, 20, 30, and 40) being spaced on opposing sides of a void (21). The void (21) may be any one of a duct, a plenum, an air exchange unit, or other space or aspect of an HVAC unit. In combination with FIGS. 5A, 5B, and 5C, the overview of the function of the LED strips (10, 20, 30, and 40) is shown. Notably, in FIGS. 5A, 5B, and 5C, three different images are shown, which displays the angle of the light source. By overlapping the LED strips (10, 20, 30, and 40), greater coverage and intensity is provided to the void (21).

Another way to increase intensity is to focus the light. LED lights function as a point light source, and this can be modified based on the use of a covering lens, whether glass or polycarbonate. In many cases, a simple polycarbonate lens is provided to protect the LED diode but to also direct the light source. The focused light is often utilized as it creates greater PAR through focusing the light to a single source. However, there is a tradeoff, in that the total intensity of the light is reduced.

As depicted in FIGS. 5A, 5B, and 5C, the particular embodiment depicts light emitting from the LED source at approximately 45° to either side of the LED diode, creating an approximately 90° spread of light. Thus, when several strips (10, 20, 30, and 40) are spaced along the length of a void (21), the light, is reflected within the void (21) to create coverage of UV-C light. While a single LED strip (10) would ultimately reflect and cover the space, the intensity would be reduced, as compared to the use of two, or three, or four LED strips. Thus, FIG. 4 depicting four spaced LED strips (10, 20, 30, and 40), shows greater coverage at a high intensity as compared to FIG. 5C, with three activated LED strips, and certainly greater than the intensity and coverage of FIGS. 5A and 5B.

However, the amount of light required to kill contaminants is based upon intensity of the UV-C light and dwell time onto the contaminant. The dwell time is impacted by the volume of the void (21) (i.e., distance of the LED diodes from the contaminant) and speed of the air traveling through the void (21). As the volume is reduced, the LED diodes are in closer proximity to the contaminant and thus require less time for decontamination (destruction of DNA-based microorganisms). As the speed of air traveling through the void (21) is diminished, there is greater dwell time of the air within the void (21) and thus greater contact with the UV-C light. Accordingly, the total number of LED lights and the total quantity of light necessary for decontamination of the contaminants passing through the void (21) depends on the volume of the void (21), the speed of the air, the distance the light source is contacting the contaminant, and the power of the UV-C light.

The best way to test the speed of the air and dwell time is to utilize a sensor (42). FIG. 6 depicts a plenum (31) comprising a coil front (32) and rear coil (33), wherein the plenum (31) comprises a sensor (42) within the plenum, which can contact flowing air. A DC power source, and preferably a controllable DC power source is a remote low voltage power hub driver (PhD) (41). The PhD contains circuitry and processing to create highly efficient connections of DC sources to DC loads, without unnecessary conversion. Accordingly, a DC source is directly coupled to at least one DC load, and allows for savings of efficiencies, which are lost in the transfer of AC to DC sources and loads. Combined with the sensor (42), which can detect air flow among other features, the devices can be utilized to modify power given to an LED diode from the PhD, and to modify a fan or duct or other feature of the HVAC system through the sensor (which contains a processor capable of sending signals to modify the HVAC system. However, the sensor may also include any number of sensors that allow for detection of a parameter useful within the system, for example, humidity, temperature, pressure, air speed, UV, lumens, irradiance, movement, etc. The PhD (41), alone, or with one or more sensors (42) can then modify the output of the LED lights based on the necessary output.

Air moves at different speeds within different HVAC systems. The speed of air is based upon the size of ducts, the length of the ducts, the number of turns in the duct system, the number of returns and vents, and the like. All of these features add up to various airflow elements for the HVAC system. The HVAC system can be modified, simply by changing the speed of a fan, or opening or closing a damper or vent to change the air requirements. Similarly, those of ordinary skill in the art will recognize that a sensor (42) can be utilized to modify the speed of a fan or open or close dampers to modify the parameters of air flow through the system at any given time. This allows for complete control and automation of the system to run at the highest efficiency within the HVAC system. As the flow of air changes within the HVAC system, the one or more LED strips (10, 20, 30, or 40) may be individually powered, powered together, partially powered, or only parts of the LED strips powered to as to meet the particular needs for the system at any given time. Given these variables, the number of LED diodes (1) on the UV-C strips (10) may vary, as may the size of the printed circuit board, the number of LED diodes on the PCB, the orientation of the LED diodes on a strip, and the length of the UV-C LED strips.

The placement of the UV-C LED strips within the ducts or the AHU plenums will vary based on the needs of the facility. The embodiments of this disclosure envision a modular approach to adapt to the different needs at any given location. However, the UV-C LED strips (10) are optimally placed as depicted in FIG. 6, to be facing the coil (32) and on opposing sides of a plenum or duct. This allows for increased efficiency of the entire system as the UV-C light will cleanse the coils to prevent or reduce the buildup of deposits while simultaneously cleaning contaminants within the air as the air passes through the plenum (31).

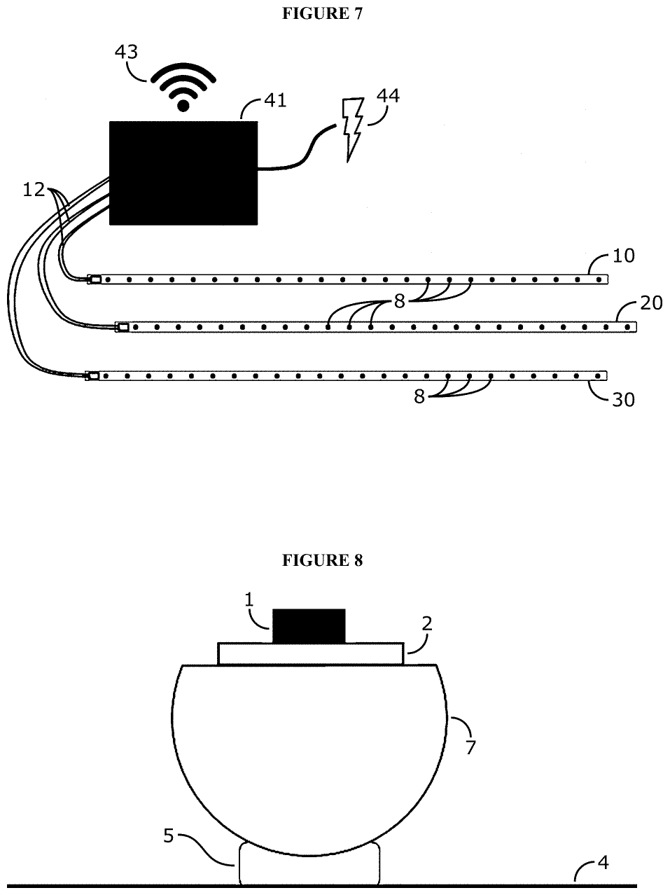

In preferred embodiments, the optional use of a PhD (41) (See FIG. 7) provides further efficiencies into the system that create unexpected cost savings. Wiring (12) directly connects the PhD (41) to three (in this example) different LED strips (10, 20, and 30), and allows for efficiencies in transmission of power between the units. The PhD base unit is connected with WiFi (43) or wired connection for control of elements connected to the PhD via wire or wireless, as well as containing the power source (44) for driving the LED strips.

The PhD provides the ideal platform to support this evolution to smart power technology. It includes multiple wireless or wired communication options and a significant array of built-in safety and performance features. The PhD supports a wide assortment of highly efficient direct current (DC) powered fixtures and loads for buildings of today and tomorrow. The PhD presents an unparalleled opportunity to provide an HVAC system within a building with full integration through a variety of renewable power sources.

The PhD converts Class 1 AC (90-305 V AC) or DC (127-431 V DC) power to multiple individual Class 2 channel outputs, which reduces installation costs. It has safe Class 2 wiring, modulates Class 2 output power to dim LED lighting to eliminate LED drivers in light fixtures (when available), integrates multiple zone 0-10 V dimming system to eliminate additional 0-10 V dimming system (not on all models), integrates wired or wireless communication to simplify commissioning of control systems. The PhD maybe air cooled, fan cooled, or fanless, comprising passive cooling for quiet, long-lasting operation. PhD elements comprise state-of-the-art Class 2 connector system for robust, adjustable, cost effective installation. Each Class 2 output (channel) has short circuit and overpower shutdown to protect low voltage installers.

Accordingly, systems that comprise the PhD system are able to more efficiently, and cost effectively control output for cost effective installation of LED lights within an HVAC system. When combined with various energy saving measures, such as relays or wiring connections that activate the LEDs to turn on when the fans for the air flow are running or are optimized based on the various sensors (42), the system can be run at unexpected efficiencies, while also providing longer lasting UV-C light output for UV-C cleaning within the HVAC system.

Several tests were performed with an LED light system of the present disclosure to identify the unexpected optimized properties of the system.

### EXAMPLES

Testing of lens data for LED lights. A simple test was created to optimize light output for the LED light strips. As a basic premise LED lights can be modified with lenses to focus the light into a narrower beam. For example, as detailed in FIGS. 4 and 5, the angle of light can be modified to be narrower or wider. A narrower path of light will create greater photosynthetically active radiation (PAR). PAR is the unit for measuring instantaneous light evident upon a surface and is measured in micromoles per square meter per second (μmol/m²/s). This is the amount of energy (photons or particles of light) hitting a square meter every second. The expectation was that use of a lens to focus the light.

Lens configurations included distances of 6, 12, 24, and 36 inches from the light source, and tested a frosted 90° lens, a clear polycarbonate 90 degree lens, a clear 90° glass lens, and no lens. The light from no lens provides a general output at 120°. The data is depicted below in Table 1.

TABLE 1
Data from a Quantum PAR Meter, detecting PAR in μmol/m²/s

| | | | | | | Performance: | Performance: | Performance: | Performance: |
|---|---|---|---|---|---|---|---|---|---|
| | | | | | | Increased | Increased | Increased | Increased |
| DATA: | | | | | | light output | percentage | light output | percentage |
| From | | | | | | of No Lens | of No Lens | of No Lens | of No Lens |
| metered | Meter Distance | | | | Light | over others | over others | over others | over others |
| testing | from Light Source | | | | Output | at 6″ | others at 6″ | at 36″ | at 36″ |
| Lens | 6″ | 12″ | 24″ | 36″ | Metered | | | | |
| Details | | | | | Output | | | | |
| Frosted | 68.2 | 30.9 | 10.7 | 6.2 | | 99.4 | 59.3% | 8.0 | 56.3% |
| Lens PC | | | | | | | | | |
| Clear Lens | 72.3 | 33.2 | 11.2 | 6.5 | | 95.3 | 56.9% | 7.7 | 54.2% |
| PC | | | | | | | | | |
| Clear | 158.4 | 67.2 | 23.8 | 13.1 | | 9.2 | 5.5% | 1.1 | 7.7% |
| Lens, glass | | | | | | | | | |
| No Lens | 167.6 | 72.4 | 26.6 | 14.2 | | | | | |

The same lenses were tested using a LUX meter. LUX is the unit of illuminance, measuring luminous flux per unit area. It is equal to one lumen per square meter. The summary is depicted in Table 2.

TABLE 2

| | | | | | | Performance: | Performance: | Performance: | Performance: |
|---|---|---|---|---|---|---|---|---|---|
| | | | | | | Increased | Increased | Increased | Increased |
| DATA: | | | | | | light output | percentage | light output | percentage |
| From | | | | | | of No Lens | of No Lens | of No Lens | of No Lens |
| metered | Meter Distance from | | | | Light | over others | over others | over others | over others |
| testing | Light Source | | | | Output | at 6″ | at 6″ | at 36″ | at 36″ |
| Lens | 6″ | 12″ | 24″ | 36″ | Metered | | | | |
| Config.: | | | | | Output | | | | |
| Frosted | 271 | 128 | 52 | 31 | | 296.0 | 52.2% | 26.0 | 45.6% |
| Lens PC | | | | | | | | | |
| Clear Lens | 332 | 143 | 61 | 36 | | 235.0 | 41.4% | 21.0 | 36.8% |
| PC | | | | | | | | | |
| Clear | 538 | 241 | 98 | 53 | | 29.0 | 5.1% | 4.0 | 7.0% |
| Lens, glass | | | | | | | | | |
| No Lens | 567 | 256 | 102 | 57 | | | | | |

In sum, at all distances tested, the no lens solution yields dramatically more light output than the frosted and clear polycarbonate lenses, and the no lens solution yields more light than the glass lens.

FROSTED POLYCARBONATE LENS: At a distance of 6″ the no lens solution yields 59.3% more light with the PAR meter and 52.2% more light with the LUX meter that the solutions with a frosted polycarbonate lens. At a distance of 36″ the no lens solution yields 56.3% more light with the PAR meter and 45.6% more light with the LUX meter as compared to the solutions with a frosted polycarbonate lens.

CLEAR POLYCARBONATE LENS: At a distance of 6″ the no lens solution yields 56.9% more light with the PAR meter and 41.4% more light with the LUX meter that the solutions with a clear polycarbonate lens. At a distance of 36″ the no lens solution yields 54.2% more light with the PAR meter and 36.8% more light with the LUX meter as compared to the solutions with a clear polycarbonate lens.

CLEAR GLASS LENS: At a distance of 6″ the no lens solution yields 5.5% more light with the PAR meter and 5.1% more light with the LUX meter that the solutions with a clear glass lens. At a distance of 36″ the no lens solution yields 7.7% more light with the PAR meter and 7.0% more light with the LUX meter as compared to the solutions with a clear glass lens. The expectation was that the clear glass lens would provide the least reduction and provide a more concentrated PAR and LUX calculation. Radiometry was also determined from prior reports for the LED lights for measuring electromagnetic radiation. There are known kill rates for certain species of contaminants and generating sufficient radiation to create log reductions is critically important. Table 3 depicts some examples of materials and their UV requirements for a 1-log and 2-log reduction.

TABLE 3

| | 90% | 99% |
|---|---|---|
| | (1-log | (2-log |
| Bacteria | reduction) | reduction) |
| Bacillus anthracis: Anthrax | 4,520 | 8,700 |
| Bacillus anthracis spores: Anthrax | 24,320 | 46,200 |
| spores | | |
| Bacillus magaterium sp. (spores) | 2,730 | 5,200 |
| Bacillus magaterium sp. (veg.) | 1,300 | 2,500 |
| Bacillus paratyphusus | 3,200 | 6,100 |
| Bacillus subtilis spores | 11,600 | 22,000 |
| Bacillus subtilis | 5,800 | 11,000 |
| Clostridium tetani | 13,000 | 22,000 |
| Ebertelia typhosa | 2,140 | 4,100 |
| Escherichia coli | 3,000 | 6,600 |
| Leptospiracanicola: infectious | 3,150 | 6,000 |
| Jaundice | | |
| Microccocus candidus | 6,050 | 12,300 |
| Microccocus sphaeroides | 1,000 | 15,400 |
| Mycobacterium tuberculosis | 6,200 | 10,000 |
| Neisseria catarrhalis | 4,400 | 8,500 |
| Phytomonas tumefaciens | 4,400 | 8,000 |
| Proteus vulgaris | 3,000 | 6,600 |
| Pseudomonas aeruginosa | 5,500 | 10,500 |
| Pseudomonas fluorescens | 3,500 | 6,600 |
| Salmonella enteritidis | 4,000 | 7,600 |
| Salmonela paratyphi: Enteric fever | 3,200 | 6,100 |
| Salmonella typhosa: Typhoid fever | 2,150 | 4,100 |
| Salmonella typhimurium | 8,000 | 15,200 |
| Sarcina lutea | 19,700 | 26,400 |
| Serratia marcescens | 2,420 | 6,160 |
| Shigella dyseteriae: Dysentery | 2,200 | 4,200 |
| Shigella flexneri: Dysentery | 1,700 | 3,400 |
| Shigella paradysenteriae | 1,680 | 3,400 |
| Spirillum rubrum | 4,400 | 6,160 |
| Staphylococcus albus | 1,840 | 5,720 |
| Staphylococcus aureus | 2,600 | 6,600 |
| Staphylococcus hemolyticus | 2,160 | 5,500 |
| Staphylococcus lactis | 6,150 | 8,800 |
| Streptococcus viridans | 2,000 | 3,800 |
| Vibrio comma: Cholera | 3,375 | 6,500 |

Molds, protozoa, viruses, and yeasts are depicted in Table 4:

TABLE 4

| | 90% kill | 99% kill |
|---|---|---|
| Molds | | |
| Aspergillius flavus | 60,000 | 99,000 |
| Aspergillius glaucus | 44,000 | 88,000 |
| Aspergillius niger | 132,000 | 330,000 |
| Mucor racemosus A | 17,000 | 35,200 |
| Mucor racemosus B | 17,000 | 35,200 |
| Oospora lactis | 5,000 | 11,000 |
| Penicillium expansum | 13,000 | 22,000 |
| Penicillium roqueforti | 13,000 | 26,400 |
| Penicillium digitatum | 44,000 | 88,000 |
| Rhisopus nigricans | 111,000 | 220,000 |
| Protozoa | | |
| Chlorella vulgaris | 13,000 | 22,000 |
| Nematode Eggs | 45,000 | 92,000 |
| Paramecium | 11,000 | 20,000 |
| Virus | | |
| Bacteriopfage: E. coli | 2,600 | 6,600 |
| Infectious Hepatitis | 5,800 | 8,000 |
| Influenza | 3,400 | 6,600 |
| Poliovirus: Poliomyelitis | 3,150 | 6,600 |
| Tobacco mosaic | 240,000 | 440,000 |
| Yeast | | |
| Brewer’s yeast | 3,300 | 6,600 |
| Common yeast cake | 6,000 | 13,200 |
| Saccharomyces carevisiae | 6,000 | 13,200 |
| Saccharomyces ellipsoideus | 6,000 | 13,200 |
| Saccharomyces spores | 8,000 | 17,600 |

Testing expectations of spatial orientation for LED lights. Influenza was identified as a logical candidate for inactivation under the LED spectrum, and so expected results were estimated for determine the most efficient manner to achieve the 3,400 or 6,600 dosage of UV radiation, as measured in μWs/cm² is needed for a 1-log or 2-log reduction in the pathogen. The samples will be tested at 67° F. In the above chart, to compute the dwell time necessary to inactivate the germs, the UV dose necessary to achieve the kill rate (as listed) is estimated at 12 inches from the pathogen, and the UV dose needs to be divided by the UV radiation dose, (for example, a known old style lamp provided a dose of 800 μWs/cm², to provide a time estimate for kill. Accordingly, Influenza at 3,400 divided by 800 yields a dwell time of 4.25 seconds. The dwell time can be calculated by the flow of air and the distance under the UV dose intensity.

The light output of the LED UV-C light without a lens creates the greatest UV dose over lensed configurations, given the increased light levels for irradiation. LED lamps can be defined to generate lights with a peak in the 278 to 282 nm wavelength range, but also a broader peak from 250 nm to 300 nm, which has known germicidal properties. By driving the lights at between 100 and 1000 mA, different levels of germicidal applications can be created. For example, as compared to the old style mercury lamps as indicated above at 254 nm peak, the LED lights, as driven as appropriate power can quickly generate sufficient radiant power for disinfection.

A test will be created with a single LED diode at a distance of 36 inches, 6 inches, and 3 inches, driven at 100 and 350 mA to determine the time for disinfection of a sample influenza viral sample at 1-log and 2-log reductions. For purposes of large air handling units, both the 36 inches (for larger and wider openings) as well as 6 and 3 inches, for ducts and such, are useful.

Notably, 1- and 2-log reductions are expected to be generated by a single LED diode generated at 100 mA at 10 seconds of duration for both 1- and 2-log reductions at 6 inches, and 18 seconds for 1-log reduction at 36 inches, and 20 seconds at 2-log reduction. These LED diodes are expected to generate approximately 20 mW at the 100 mA. Driving the units at 350 mA may generate closer to 120 mW, showing an increase in efficiency. This generates a dramatic reduction in the necessary time, while still only utilizing fractions of watts of power for the LED diode. At 6 inches and driven at 350 mA, the time was only 3 seconds for 1- and 2-log reductions, while the 36 inches provided 4 and 5 second reduction times from the test samples. A further estimation at 3 inches estimated a reduced time again by approximately one half from the 6-inch test.

A second set of samples will be tested with three diodes on a single PCB to generate an estimated increase of approximately 2.8 times the power of the single LED diode based on prior data and studies. Identifying that optimization of the LED lights (8) within a given space can increase the UV-C disinfection power, as necessary.

Reviewing prior test results and data, a further test will identify certain orientations of the LED strips, over a given distance at 1000 cfm, with air temperature at 67° F. The duct will be sized to move a given particle at a flow rate of 400 feet per minute (FPM), or nominally at 6.67 ft/s. For our purposes, a 12-foot space will be provided with reference LED strips, allowing a nominal dwell time of under 2 seconds.

Accordingly, based on an estimated calculation of the flow and power of the LED diodes, a single LED strip within a 12-inch duct will be provided so that the air is on average 6 inches from the LED and we nearly achieved the 1-log reduction over 12 feet of LED strip lights. However, by orienting a second LED strip on the opposing side of the duct, the average distance becomes 3 inches, it is expected to be possible to generate sufficient UV-C for disinfection at, at least 1-log reduction at these flow rates over this distance with the estimated power. Increasing the LED lights (8) within the space can create greater UV-C dose, to appropriately size the power of the disinfection system based on the expected air flow of each system and the rate and power of UV-C desired. Thus, the modular system described herein allows for tailored approaches based on the particular facts and needs of each system. Furthermore, with expected improvements in the output of LED diodes, these numbers will be expected to be further improved.

Notably, an older style tube light based on prior published examples, but also as will be tested in the same apparatus and is expected to generate less light at the same intensity, but at a greater power draw. Furthermore, the tube light reduced the efficiency of the air flow by 20%, in addition to the increased power needs for generated an equivalent amount of UV-C light. Putting two of the old tube style lights on opposing sides in a single duct may not be possible, as the reduction of flow may be so substantial that it impacts the performance of the unit as a whole.

In sum, by using the LED UV-C light without a lens, installers can reduce the distance needed at given air speeds to generate a sufficient UV-C dose within a normal distance (i.e., a 12-foot section of ducting), where it is possible to reduce contaminant loads through UV-C. This can then be combined with any other filtration device, as desired to increase the efficiency of the system as a whole.

Secondly, by orienting in an opposing pattern, LED UV-C light will increase the effective (average) UV dose, and reduced the time/distance necessary. This may have a dramatic improvement, even in the small space of a single duct. This may simply not be a possible solution using tube UV applications, because their size (bulkiness) creates too much disturbance to the air flow in the system. By orienting LED strips in a simple opposing pattern, dramatically improved kill rates should be identified within the system, while still operating at a lower power consumption than prior UV tubes.

Finally, when the system was installed to also provide UV-C light to the coil (32), the system may generate even further efficiencies. A biofilm of even 0.002 inches has been cited to reduce efficiency by 37%. By application of the UV-C light to the coil, the biofilm can be destroyed or dramatically reduced, and thus reduce the cleaning needs of the coils. The UV-C continually cleans the coils, thus preventing or reducing the buildup over time. A test is expected to run using intentionally dirty air through a closed system, with and without the UV-C LED lights illuminated. The test will run for a predetermined duration, and the total accumulation of particulate and biofilm will be measured to determine effectiveness compared to control. While it is expected that some dirty particulates still accumulated in both situations, the use of the UV-C should reduce the accumulation by the aforementioned up to 37%, as compared to the no LED strip test. Accordingly, in factoring these features, the setup of, for example, FIG. 6 can help to further optimize the system, where the opposing LED strips provide the greatest efficiency for contact time for UV-C sterilization purposes, while also maintaining efficiencies and increasing efficiencies of the system.

Energy efficiency of using a DC power source, such as the PhD system for LED UV-C Lights and mercury-based UV-C tubes is expected to generate further and substantial advantages to the system with regard to power consumption and optimization of the power based on the flow of air through the system. For example, LED UV-C Lights and mercury based UV-C tubes typically have a 12% to 20% (average 16%) energy loss in converting the alternating current (AC) to direct current at the lighting device. By use of the PhD system, the LED lights gain a substantial energy efficiency over standard AC configurations.

Further efficiencies are also gathered by the PhD system including that LED UV-C Lights and mercury-based UV-C tubes typically have a 3% to 6% (average 4.5%) energy loss in converting the alternating current (AC) to direct current at the “hub” vs at each lighting device. Accordingly, adding a PhD device into the system generates further energy efficiencies on average energy loss of 16% down to 4.5% for a net energy savings of 11.5% of the energy consumption for both LED UV-C lights and mercury-based UV-C tubes.

Accordingly:
1. LED strips have a lower profile than UV-C tubes, which reduces static pressure on the ducts to increase air flow and save energy. Nominally, the efficiency is nearly a 20% gain over a comparable tube within the system.
2. LED strips without lenses yield more light output than strips with lenses, which increase light output, increases irradiation dosage for disinfection, and saves energy, because the LED lights can be run at a lower power, or fewer lights are needed to generate the UV-C dose necessary for disinfection.
3. LED strips run with a DC power system such as a PhD saves energy and saves labor time in wiring with low voltage connections to each luminaire.

While particular elements, embodiments and applications of the present invention have been shown and described, it will be understood, of course, that the invention is not limited thereto since modifications may be made by those skilled in the art without departing from the spirit and scope of the present disclosure, particularly in light of the foregoing teachings.

What is claimed is:

1. An air disinfection system comprising:
a plurality of LED diodes mounted on an LED strip;
a driver for driving the LED diodes to a given power; and
a DC power source configured for direct connection to the LED strip;
the system configured for positioning within a heating, ventilation, and air conditioning (HVAC) system, wherein said system comprising at least a first LED strip and a second LED strip, said first LED strip mounted opposing said second LED strip within a void within the HVAC system;
wherein air passing through said void is contacted by irradiated light from the LED diodes.

2. The system of claim 1 wherein the LED diodes are driven at between 100 mA and 350 mA.

3. The system of claim 1 wherein the LED diodes are driven to generate light with a peak between 255 nm and 280 nm.

4. The system of claim 1 further comprising a sensor, said sensor detecting a flow of air and capable of modifying intensity of light based upon the flow of air.

5. The system of claim 1 wherein the first LED strip and the second LED strip are mounted to irradiate a coil within the HVAC system.

6. The system of claim 1 wherein said DC power source comprises multiple channels to power multiple LED devices in different areas of the HVAC system.

7. The system of claim 6 wherein said DC power source has multiple channels to power multiple devices in different areas of any given building that may include multiple air handling units (AHUs) and ducts.

8. The system of claim 6 wherein said DC power source includes wireless controls.

9. A method of air disinfection by using ultraviolet wavelength light-emitting diodes (UV-LEDs) comprising:
on opposing sides in a void within a heating, ventilation, and air conditioning (HVAC) system, mounting a plurality of UV-LEDs that are fixed on a circuit board and a backing element, which is attached to a surface within the HVAC system;
detecting a flow of air through the HVAC system; and
driving the UV-LEDs to a power sufficient to generate an output based upon the flow of air through the HVAC system.

10. The method of claim 9 wherein the void is the inside of an HVAC duct.

11. The method of claim 9 wherein the void is the inside of an HVAC air handling unit (AHU).

12. The method of claim 9 wherein the backing element comprises an adhering agent.

13. The method of claim 12 wherein in the adhering agent is selected from the group consisting of: an adhesive, a magnet, a threaded fastener, a bracket and fastener, and combinations thereof.

14. The method of claim 9 wherein the UV-LEDs are configured on an LED strip.

15. The method of claim 14 further comprising a DC power source, wherein the DC power source for the LED strip is local to each LED strip.

16. The method of claim 15 wherein the DC power source for the LED strip is remote from the LED strip through a power hub driver.

17. The method of claim 9 further comprising: engaging a sensor to detect the flow of air through the HVAC system and modifying the output of the UV-LEDs based upon the flow of air.

18. A system for UV disinfection comprising:
a plurality of UV-C LED diodes, each UV-C Diode positioned on a printed circuit board (PCB), and affixed to a backing on a LED strip;
said LED strip electrically connected to a DC power source, for direct DC power to said LED strip;
an HVAC void, wherein at least two LED strips are positioned substantially opposite of one another; and
a sensor connected to said DC power source for detecting a parameter and capable of modifying the DC power source or an element of an HVAC system to modify a flow of air within the HVAC system.

19. The system of claim 18 wherein the UV-C LED diodes are driven at between 100 mV and 350 mV and wherein the UV-C LEDs provide a light emission with a peak between 255 nm and 280 nm.

20. The system of claim 18 wherein said sensor is selected from the group consisting of: humidity, temperature, pressure, air speed, UV, lumens, irradiance, movement, and combinations thereof.
